(19) United States
(12) Patent Application Publication
(10) Pub. No.: US 2002/0090099 A1
(43) Pub. Date: Jul. 11, 2002

(54) Hands-free, wearable communication device for a wireless communication system

(76) Inventor: Sung-gul Hwang, Evanston (KR)

Correspondence Address: MOTOROLA INC, 600 NORTH US HIGHWAY 45, LIBERTYVILLE, IL, 60048-5343, US

(21) Appl. No.: 09/756,055

(22) Filed: Jan. 8, 2001

(51) Int. Cl. H04R 25/00

(52) U.S. Cl. 381/312; 381/315; 381/322

(57) ABSTRACT

The subject invention is a portable communication device (100) having a lanyard-like structure that is generally hung around a user's neck. In particular, the device includes an earpiece (106) for providing incoming audio or voice information to the user's ear and a mouthpiece (104) to receive outgoing audio or voice information from the user's mouth. Also, one end (108) of a flexible elongated cord (102) is attached to one part (216) of the mouthpiece, and the cord passes through another part (212) of the mouthpiece to form a loop to one side of the mouthpiece that is placed over the user's head. The mouthpiece may be adjusted to many different positions along the cord. The earpiece is attached to the other end (110) of the cord and may either hang down from the mouthpiece or be positioned on the user's ear. An electrical conductor (202) is positioned through the cord to electrically connect the mouthpiece to the earpiece, and a wireless transceiver (404) and a microphone (408) are located in the mouthpiece. When the earpiece is positioned on the user's ear, the earpiece directs the cord toward the user's mouth so that the mouthpiece is positioned near the user's mouth.

### FIELD OF THE INVENTION

The present invention relates generally to the field of hands-free accessories for telecommunication devices. More particularly, the present invention relates to wearable headsets for wireless communication with other devices in close proximity to the headset.

### BACKGROUND OF THE INVENTION

An electronic communication device, such as a radiotelephone, 2-way radio, and multiple communication device, is generally held adjacent to a user's ear and mouth when in use. At other times, the user may hold the device in his or her hand, use a clip or holster to conveniently carry the device, or set the device on a nearby surface when it is not in use. To avoid the hassle of carrying the device, the user may wear an accessory or, more particularly, a headset connected to the device to conduct a telephone conversation using the device.

Many communication devices have accessories or headsets that may be supported on a user's head. In particular, a headset for a device may rest on a user's head and position a speaker over one or both of the user's ears. One example of such headset is the Headset With Boom Microphone (ref. HSK9500) produced by Motorola, Inc of Schaumburg, Ill., U.S.A. The Headset With Boom Microphone includes an earpiece having a boom microphone extending therefrom. The boom microphone is a substantially rigid, linear bar that places a microphone at a fixed position in front of the earpiece. The Headset With Boom Microphone also includes a cord having an audio plug at one end to provide a wireline connection to the wireless communication device.

Headsets may include transceiver circuits for wireless communication with the wireless communication devices, particularly radiotelephones. For example, the Ericsson T18Z and T28 “world phones” may include a Bluetooth radio module for wireless communication with a Bluetooth headset. Similar to the Headset With Boom Microphone described above, the Bluetooth headset of the T18Z or T28 phone includes an earpiece having a substantially rigid, linear boom microphone extending therefrom. The headset also includes a transceiver circuit for wireless communication with the phone. Unfortunately, the above accessories and headsets are inconvenient and intrusive to carry on one's head, particularly when they are not in use.

Accessories for wireless communication devices may also be supported on a user's upper body instead of the user's head. For example, lanyard necklaces used to support wireless devices, such as radios, pagers and radiotelephones, on the user's chest are known in the art. An example of such lanyard necklace is the StarTAC® Black Cloth Lanyard Necklace produced by Motorola, Inc. The Lanyard Necklace is a large cloth loop that fits over the user's head and rests on the user's shoulders and neck. One part of the loop is attached to the wireless device so that the device is supported on the user's chest. This type of lanyard necklace provides a conveniently located support for the wireless communication device. However, the above accessories and headsets do not provide convenient positioning near the user's ear and mouth.

Another example of a lanyard necklace for a wireless device is the LPS-1 Inductive Loopset produced by Nokia of Espoo, Finland. The LPS-1 Inductive Loopset includes a wireloop that is positioned around the user's neck and connects to a module that rests on the user's chest. A cord provides a wireline connection between the module and a radiotelephone. The Loopset transmits speech from the radiotelephone to a hearing aid in the user's ear and receives speech at a built-in microphone of the module that, as stated above, rests on the user's chest. However, the above accessories and headsets do not provide convenient positioning near the user's ear and mouth, particularly if the user does not use a hearing aid.

Some accessories may be supported by a user's head and attached to one's clothing. One example of a head & clothing-supported headset is the Walk & Talk Headset (ref. HSK9000) produced by Motorola, Inc. The Walk & Talk Headset is a cord having a speaker at one end and an audio plug at the other end. A microphone and a supporting clip are located at fixed positions along the cord between the speaker and the audio plug. The headset is supported on the user's chest by placing the speaker in the user's ear and attaching the supporting clip to an article of the user's clothing. The microphone hangs down directly from the user's ear and is positioned on or above the user's shoulder or thereabouts. The audio plug provides a wireline connection between the wireless communication device and the microphone & speaker of the headset. Similar to the other accessories and headsets described above, the head & clothing-supported headset is inconvenient and intrusive to carry on one's clothing and does not provide convenient positioning near the user's ear and mouth

Accordingly, it would be desirable to a user to have an accessory or headset for a communication device that is convenient and unintrusive to carry and provides proper positioning for conducting telephone conversations. When the accessory is not in use, the accessory should allow the user to continually and easily wear it and avoid any limitation to the mobility of the user, such as a connecting cord. When the accessory is used for conducting a telephone conversation, the accessory should have the ability to be positioned near the user's ear and mouth for proper usage. It is also desirable to have an accessory or headset that is aesthetically pleasing and fashionable for the user to wear and, in addition, adjustable to the physical size of the user's body.

### BRIEF DESCRIPTION OF THE DRAWINGS

FIG. 1 is a front plan view of a communication device of the present invention hanging down from an upper body of a user;

FIG. 2 is a magnified, front plan view of the communication device of FIG. 1;

FIG. 3 is a magnified, side plan view of the communication device of FIG. 1;

FIG. 4 is a block diagram of the electronic components of the communication device of FIG. 1; and

FIG. 5 is a side perspective view of the communication device of FIG. 1 in which one part is supported by the user's ear.

### DETAILED DESCRIPTION OF THE PREFERRED EMBODIMENT

There is generally provided a portable, wireless communication device supported by an upper body of a user having a lanyard-like structure that is generally hung around the user's neck. In particular, the device includes an earpiece for providing incoming audio or voice information to the user's ear and a mouthpiece to receive outgoing audio or voice information from the user's mouth. Also, one end of a flexible elongated cord is attached to one part of the mouthpiece, and the cord passes through another part of the mouthpiece to form a loop to one side of the mouthpiece that is placed over the user's head. The mouthpiece may be adjusted to many different positions along the cord. The earpiece is attached to the other end of the cord and may either hang down from the mouthpiece or is positioned on the user's ear. An electrical conductor is positioned through the cord to electrically connect the mouthpiece to the earpiece, and a wireless transceiver and a microphone are located in the mouthpiece. When the earpiece is positioned on the user's ear, the earpiece directs the cord toward the user's mouth so that the mouthpiece is positioned near the user's mouth.

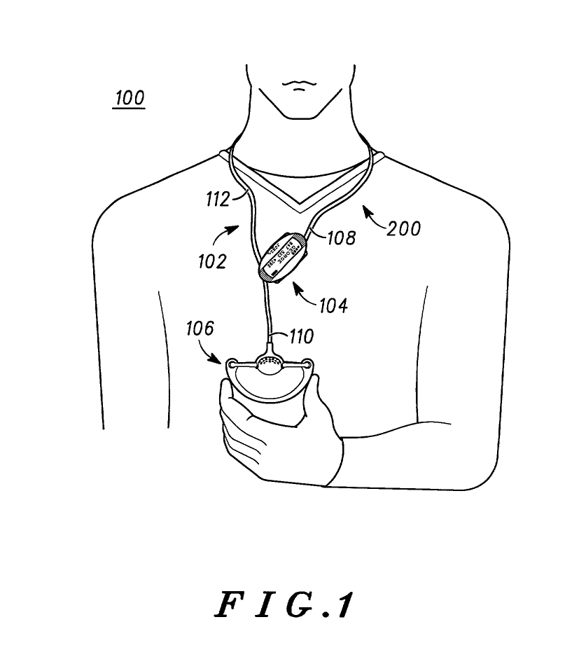

Referring to FIG. 1, the preferred embodiment 100 of the portable, wireless communication device of the present invention includes a cord 102, a mouthpiece 104 and an earpiece 106. The cord 102 includes a first end 108, a second end 110 and a flexible elongated body 112 therebetween. The cord 102 may be made of any type of light flexible material, such as cloth, string, plastic or nylon, that rests comfortably around the neck and on the shoulders of a user as shown in FIG. 1. The mouthpiece 104 is connected to the first end 108 of the cord 102, and the earpiece 106 is connected to the second end 110 of the cord.

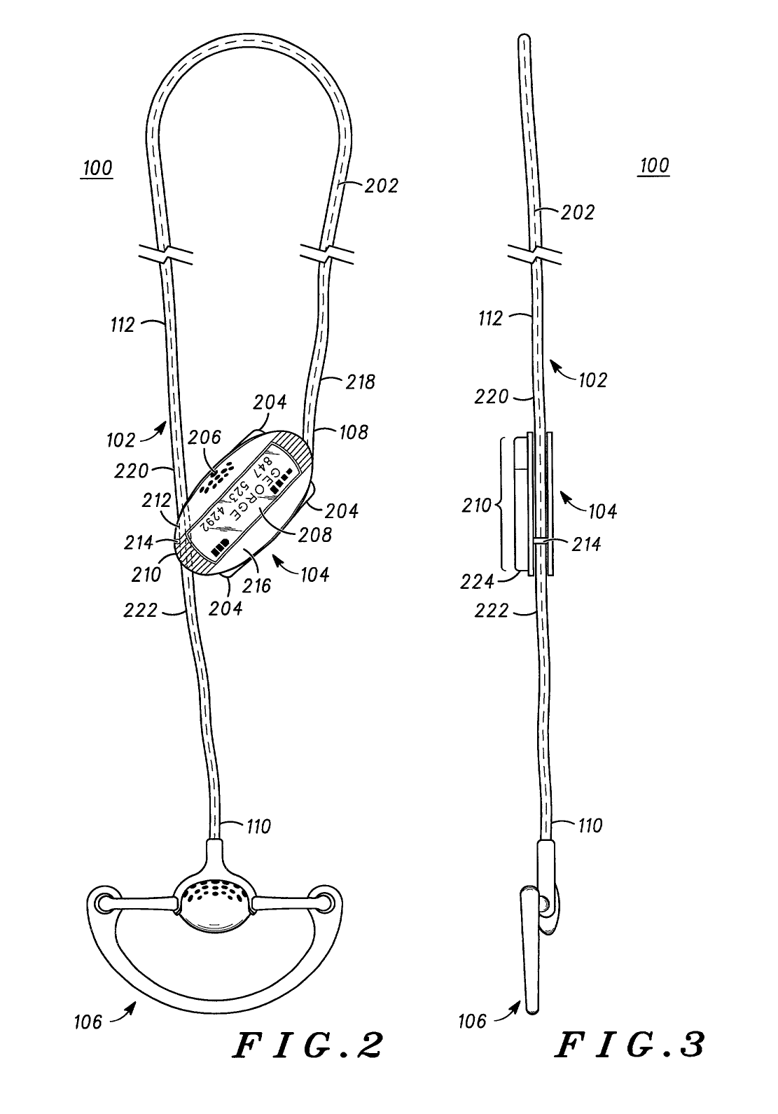

Referring to FIGS. 2 and 3, an electrical conductor 202 extends through the body 112 of the cord 102 to electrically connect the first and second ends 108, 110 of the cord. Thus, the electrical conductor 202 is a single continuous line that electrically connects the mouthpiece 104 to the earpiece 106. In addition, an inner line, wire or cable may add partial structural firmness to the generally non-rigid structure of the cord 102. Such inner line may be the electrical conductor 202 or, in the alternative, a separate component positioned in the cord 102 with the electrical conductor.

The mouthpiece 104 of the cord 102 may take any shape that is small and unintrusive to the user. For the preferred embodiment shown in FIGS. 2 & 3, the mouthpiece 104 has an ovular shape with three selection buttons 204 protruding from its outer edge. However, it is to be understood that the mouthpiece 104 of the present invention may have any convenient, unintrusive form that permits the device to function as described herein. In addition, the selection buttons 204 are not intended to be the same particular shape, location or quantity of the preferred embodiment.

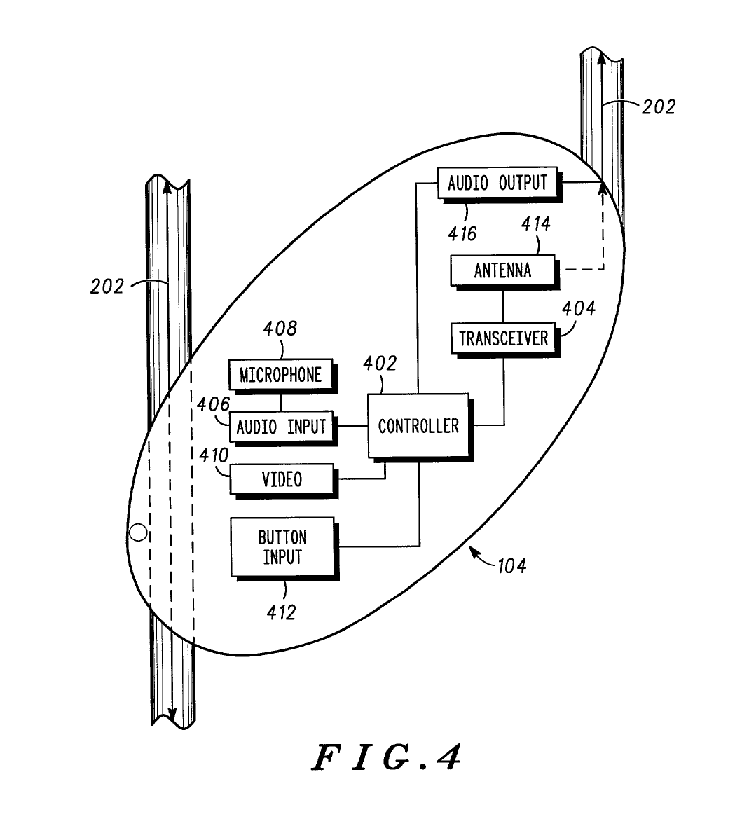

The mouthpiece 104 of the preferred embodiment 100 includes microphone apertures 206 and a display 208 on its exterior surface. The microphone apertures 206 are positioned over a microphone (shown in FIG. 4) that receives audio information from the user's mouth. The display 208 is preferably a liquid crystal display that provides one or more lines of information and/or graphic indicators to the user. Such information and indicators include, but are not limited to, time and date, caller identification name, caller identification number, received signal strength, call in progress, message status, out-of-range or within-range indicator, or power supply level. For the preferred embodiment, the information and indicators shown on the display 208 are provided upside-down so that the user may properly view them when the mouthpiece is flipped-upward in front of the user's face. It is expected that this flipped-upward orientation would be a desirable way for the user to view the display 208.

As shown in FIGS. 2 & 3, the mouthpiece 104 of the preferred embodiment 100 is capable of supporting a subsection 210 of the flexible elongated body 112 of the cord 102. The subsection 210 is at least partially enclosed within a retaining portion 212 on one side of the mouthpiece 104. Thus, the body 112 of the cord 102 passes through the retaining portion 212 of the mouthpiece 104. The retaining portion 212 is capable of being adjustably positioned along the body 112 of the cord 102 and maintaining itself at a particular position along the body by holding or gripping an outer peripheral surface of the body. For the preferred embodiment, the subsection 210 is maintained within the retaining portion 212 of the mouthpiece 104 by a retaining pin 214. In addition to the retaining portion 212, the mouthpiece 104 also include a circuit portion 216 to support the various electronic components of the preferred embodiment 100 which are described in detail below in reference to FIG. 4.

There are essentially three cord portions that extend from the mouthpiece of the preferred embodiment 100. First and second cord portions 218, 220 of the cord 102 extend from an upper part of the mouthpiece 104, and a third cord portion 222 of the cord extends from a lower part of the mouthpiece (substantially opposite the upper part). The first and second cord portions 218, 220 are capable of supporting the mouthpiece 104 at a carrying position 200 shown in FIG. 1. The first cord portion 218 is continuous with the second cord portion 220 so that the first cord portion, the second cord portion and the upper part of the mouthpiece form a continuous loop. This continuous loop fits over the user's head, rests on the user's shoulders and sets against the back of the user's neck.

The retaining portion 212 is adjustable along the body 112 of the cord 102 and adjusts the size of the continuous loop. Specifically, the continuous loop becomes larger as the mouthpiece 104 is positioned closer to the earpiece 106, and the continuous loop becomes smaller as the mouthpiece is positioned away from the earpiece. Accordingly, the continuous loop may be adjusted to a size appropriate for the height and size of the user. Also, the continuous loop may be enlarged to fit it over the user's head and reduced after it has been situated on the user's shoulders.

Referring specifically to FIG. 3, the mouthpiece 104 further includes a power source 224 to provide electrical power to the various electronic components of the circuit portion 216, which are described in further detail below.

Referring to FIG. 4, the mouthpiece 104 of the preferred embodiment 100 includes various electronic components to provide certain features for the device. In particular, the mouthpiece 104 includes a controller 402, a wireless transceiver circuit 404, and an audio input 406. The controller 402 is the central processor for the preferred embodiment 100 and provides communication, user interaction and advance functions for the other electronic components. An example of an advance function includes, but is not limited to, voice recognition capabilities to convert spoken numbers to a viable telephone number which may, in turn, be transmitted by the transceiver circuit 404 to a remote device. The audio input 406 is, preferable, connected to a microphone 408 and is used to communicate audio information to the controller 402. The audio input 406 may also include circuitry to enhance the sound quality of such audio information.

The transceiver circuit 404 is any type of wireless communication circuit that may communicate with other wireless devices, such as a radiotelephone, cordless phone, and the like. The transceiver circuit 404 transmits outgoing communication signals to a remote device and receives incoming communication signals from the remote device. Preferably, the transceiver circuit 404 uses a protocol that communicates with one or more devices via a communication protocol for short-range wireless communication. For example, the preferred embodiment 100 uses a spread spectrum communication system using the 2.4 GHz. portion of the radio spectrum. Such systems utilizes frequency hopping technologies such as Bluetooth which is supported by the Bluetooth Special Interest Group and Home RF which is supported by the HomeRF Working Group as well as direct sequence technologies such as Wi-Fi (IEEE 802.11b by the Institute of Electrical and Electronics Engineers). The transceiver circuit 404 may also use other protocols for wireless communication such as cellular communication systems and paging systems.

For the preferred embodiment, the mouthpiece 104 also includes a video circuit 410 and button input 412. The video circuit 410 provides the electronic circuitry necessary to provide one or more lines of information and/or graphic indicators on the display 208 (shown in FIG. 2), and the button input 412 receive user input when the user desires a particular action or function. The video circuit 410 provides status information on the display 208, and the status information on the display is responsive to actuation of one or more selection buttons 204 (shown in FIG. 2). Similar to the description above with regard to the display 208, examples of such status information provided by the video circuit 208 include time and date, caller identification, received signal strength, call in progress, message status, out-of-range or within-range indicator, or power supply level. The button input 412 may be used to control selection buttons 204 (shown in FIG. 2) to operate volume, initiate calls, answer calls, end calls, enter phone numbers, and select various options on a menu system.

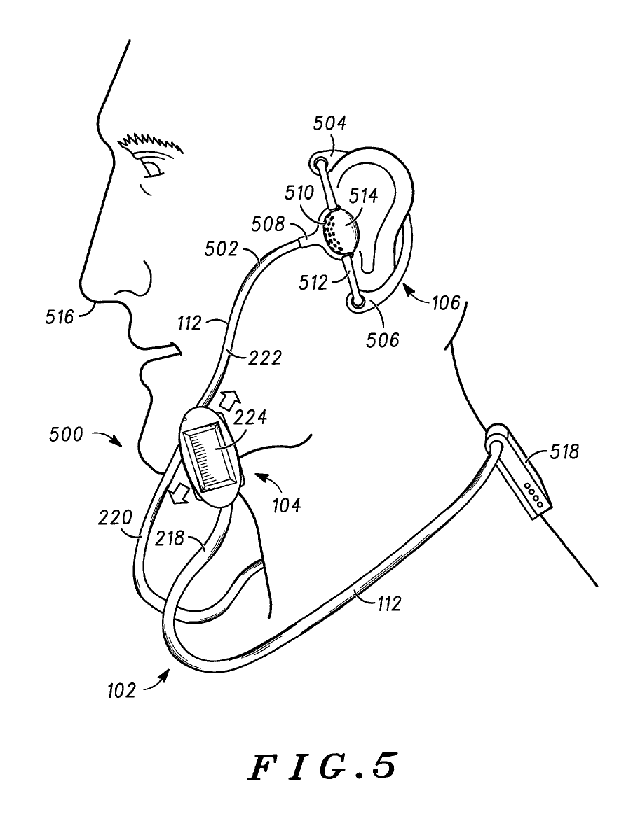

The mouthpiece 104 may also includes an antenna 414 and an audio output 416. The antenna 414 is coupled to the transceiver circuit 404 for transmission and reception of communication signals to and from one or more remote devices. The audio output 416 is, preferably, circuitry necessary to couple a speaker (shown in FIG. 5) to the controller 402 and/or enhance the sound quality of the audio information. However, it is to be understood that the antenna 414 and audio output 416, or a portion thereof, may also be positioned at another part of the communication device, such as the cord 102 or earpiece 106. For example, in the preferred embodiment, the antenna is located in the mouthpiece 104 and the audio output 416 is connected to a speaker located in the earpiece 106 by the electrical conductor 202. Electrical conductor 202 connects the mouthpiece 104 or, more specifically, the controller 202 to a speaker of the earpiece 106. (This speaker is described in more detail below in reference to FIG. 4.) Likewise, the antenna 414 may be positioned in the communication device to maximize the reception and transmission capabilities of the transceiver circuit 404.

It is to be understood that the various electronic components of the mouthpiece 104 shown in FIG. 4 represent the circuitry of the preferred embodiment. An actual circuit utilizing the present invention may have a variety of configurations to perform the functions of these components, and are limited only by the physical dimensions of the mouthpiece and the volume required for the retaining portion 212. For example, the controller 402, transceiver 404, audio input 406, video 410, button input 412 and audio output 416 may be integrated within a single programmable integrated circuit.

The communication device of the present invention has at least two positions that may be applied by the user: a carrying position 200 (shown in FIG. 1) discussed above in reference to FIG. 1 and a communicating position 500 discussed below in reference to FIG. 5. Thus, the mouthpiece 104 has a communicating position near the mouth of the user and a carrying position 200 away from the mouth of the user. The carrying position 200 and the communicating position 500 may be applied to any embodiment of the present invention, including the preferred embodiment 100 described above.

Referring to FIG. 5, there is shown a user having the preferred embodiment 100 of the present invention in the communicating position 500. Shown upside-down in FIG. 5, the first and second cord portions 218, 220 of the cord 102 extend from an upper part of the mouthpiece 104, and the third cord portion 222 of the cord extends from a lower part of the mouthpiece (substantially opposite the upper part). The first cord portion 218 is continuous with the second cord portion 220 to form a continuous loop that fits over the user's head, rests on the user's shoulders and sets against the back of the user's neck. The second cord portion 220 is also continuous with the third cord portion 222 and may pass through the mouthpiece 104.

The first and second cord portions 218, 220 are capable of supporting the mouthpiece 104 at the carrying position 200 shown in FIG. 1, and the third cord portion 222 is capable of supporting the mouthpiece 104 at the communicating position 500 shown in FIG. 5. Although the third cord portion 222 provides primary support to the mouthpiece 104 at the communicating position 500, the first and second cord portions 218, 220 provide secondary support to the mouthpiece as well. In particular, the first and second cord portions 218, 220 of the cord 102 effectively center the mouthpiece 104 in front of the user at the communicating position 500. The combination of supporting the mouthpiece 104 from the user's ear and directing it towards the front of the user is effective to situated the mouthpiece, particularly the microphone apertures 206 (shown in FIG. 2), near the user's mouth.

The earpiece 106 capable of being supported by the user's ear and is effective to direct the flexible elongated body 112 of the cord 102 toward the user's mouth so that the mouthpiece 104 is positioned near the mouth. The body 112 of the cord 102 has a generally non-rigid structure made of a light flexible material, such as cloth, string, plastic or nylon, that may rest comfortably around the user's neck and on the user's shoulders. The cord 102 may include an embedded structural support or compound, such as the electrical conductor 202 (shown in FIGS. 2 & 3), to provide some firmness to its generally non-rigid structure. Although the body 112 will have some firmness to partially maintain its structure, it is susceptible to contours of adjacent surfaces (such as the user's face) as well as gravitational forces. Thus, one end 502 of the cord 102 supports the remaining portion of the cord and permits the remaining portion, as well as the mouthpiece 104, to hang downward therefrom.

The earpiece 106 includes a hanging portion having upper and lower hanging portions 504, 506, a support stem 508, and a speaker 510. The hanging portion 504, 506 may be positioned over the user's ear and has a substantially linear front segment 512 that is positioned at one side of said ear and directs the body 112 of the cord 102 toward the user's mouth. More particularly, the hanging portion 504, 506 supports the support stem 508 at a midpoint or mid-area 514 of the front segment 512 and directs the body 112 of the cord 102 substantially perpendicular to the front segment. Also, the upper and lower hanging portions 504, 506 are substantially similar in shape so that the earpiece 106 is symmetrical in design. Due to this symmetrical characteristic of the earpiece 106, it may be positioned on either ear of the user. Also, the speaker 510 provides incoming audio information to the user's ear as described above.

The support stem 508 has a more rigid structure than the body 112 of the cord 102 and aims the body toward an area above the user's mouth or, more specifically, toward the nostril area 516 of the user. In fact, the support stem 508 is preferable made of a substantially rigid material, such as molded plastic or firm rubber, that retains its shape despite any external forces that are subjected to it. As the body 112 approaches the nostril area 516 of the user and curves downward due to gravitational forces, the mouthpiece 104 is naturally situated near the user's mouth. Although not shown in FIG. 5, the support stem 508 may have an alternative embodiment that is adjustable relative to the hanging portion 504, 506 to adjustably position the mouthpiece 104 near the user's mouth.

The portable communication device of the present invention may also include an optional module 518 attached to the body 112 of the cord 102. As shown in FIG. 5, the module 518 may be attached to the body 112 so that it hangs there from against the back of the user's neck. The module 518 hangs from this position for the carrying position 200 as well as the communicating position 500. The module 518 is coupled to the electrical conductor 202 (shown in FIGS. 2 & 3) and may include a latch mechanism for coupling to and uncoupling from the electrical conductor. The module 518 may be used as a primary power source to substitute the power source 224 of the mouthpiece 104, a secondary power source to supplement the power source of the mouthpiece, or a second housing for the various electronic components of the mouthpiece shown in FIG. 4.

In addition, a grip or sole (not shown) may be positioned on one side of the module 518 to secure or adhere the module against a back neck area of the user. The grip or sole prevents undesirable movement or slipping of the module 518 in the downward and lateral directions. The grip or sole may be made of any type of material that has frictional properties against the user's skin or clothing, such as rubber, foam or felt.

The present invention provides an accessory or headset for a communication device that is convenient and unintrusive to carry and provides proper positioning for conducting telephone conversations. The accessory is particularly convenient for those people who frequently receive calls. The communication device may simply be picked-up to make a call and released when the call is terminated. The present invention is more convenient to access than other accessories that must be placed in, and retrieved from, one's bag, pocket or belt clip.

The accessory has a convenient carrying position in which the device is carried on the user's shoulders about the user's neck like a necklace or lanyard. In this position, the earpiece of the accessory may be aesthetically pleasing and hangs down to the middle of the user's chest like jewelry. Thus, the accessory is easy to transport and may be fashionable to wear. The accessory also has an effective communicating position in which the earpiece is positioned on the user's ear. The cord has two parts that effectively position the mouthpiece near the user's mouth: a first and second cord portion that forms a loop around the user's neck and a third cord portion that is directed toward the front of the user's face. The mouthpiece is positioned near the user's mouth due to the structure of the earpiece and the composition of the cord. Therefore, the light and flexible structure of the accessory is capable of positioning itself properly for the user to conduct telephone conversations.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A portable communication device supported by an upper body of a user, said device being effective to provide incoming audio information to an ear of said user and to receive outgoing audio information from a mouth of said user, the device comprising:
a cord including a first end and a second end, said cord having a flexible elongated body between said first and second ends;
a mouthpiece connected to said first end of said cord; and
an earpiece connected to said second end of said cord, said earpiece capable of being supported by said ear of said user, said earpiece being effective to direct said flexible elongated body of said cord toward said mouth of said user so that said mouthpiece is positioned near said mouth.

2. The portable communication device of claim 1, wherein said flexible elongated body of said cord has a non-rigid structure that permits said first end to hang downward from, and be supported by, said second end.

3. The portable communication device of claim 1, wherein said earpiece includes a hanging portion that may be positioned over said ear of said user.

4. The portable communication device of claim 1, wherein said earpiece includes a speaker portion to provide said incoming audio information to said ear of said user.

5. The portable communication device of claim 1, wherein said earpiece includes a support stem to direct said flexible elongated body of said cord toward said mouth of said user.

6. The portable communication device of claim 5, wherein said support stem has a more rigid structure than said flexible elongated body of said cord.

7. The portable communication device of claim 5, wherein said support stem aims said flexible elongated body of said cord to an area above said mouth of said user so that, as said flexible elongated body curves downward due to gravity, said mouthpiece is position near said mouth.

8. The portable communication device of claim 1, wherein said earpiece comprises:
a hanging portion that may be positioned over said ear of said user, said hanging portion having a substantially linear front segment that is positioned at one side of said ear; and
a support stem supported by said hanging portion adjacent to said ear, said support stem being effective to direct said flexible elongated body of said cord substantially perpendicular to said substantially linear front segment of said hanging portion.

9. The portable communication device of claim 8, wherein said support stem is supported by said hanging portion at a midpoint of said substantially linear front segment.

10. The portable communication device of claim 1, further comprising an inner line extending through said flexible elongated body of said cord to provide partial structural firmness to said body.

11. A wireless communication device supported by an upper body of a user, said device being effective to provide incoming audio information to an ear of said user and to receive outgoing audio information from a mouth of said user, the device comprising:
a cord including a first end, a second end, and an electrical conductor connecting said first and second ends;
a mouthpiece connected to said electrical conductor at said first end of said cord, said mouthpiece including a wireless transceiver and a microphone; and
an earpiece connected to said electrical conductor at said second end of said cord.

12. The wireless communication device of claim 11, wherein said wireless transceiver transmits outgoing communication signals to a remote device and receives incoming communication signals from said remote device.

13. The wireless communication device of claim 12, wherein said remote device is a radiotelephone.

14. The wireless communication device of claim 13, wherein said wireless transceiver of said mouthpiece communicates with said remote device via a communication protocol for short-range wireless communication.

15. The wireless communication device of claim 11, further comprising an antenna coupled to said wireless transceiver.

16. The wireless communication device of claim 11, further comprising a display positioned on said mouthpiece, said display being effective to provide status information on said display.

17. The wireless communication device of claim 16, further comprising at least one selection button positioned on said mouthpiece, said status information on said display being responsive to actuation of said at least one selection button.

18. A portable communication device supported by an upper body of a user, said device being effective to provide incoming audio information to an ear of said user and to receive outgoing audio information from a mouth of said user, the device comprising:
a mouthpiece including a microphone to receive said audio information, said mouthpiece having a first position near said mouth of said user and a second position away from said mouth of said user;
first and second cords extending from said mouthpiece, said first and second cords being capable of supporting said mouthpiece at said second position; and
a third cord extending from said mouthpiece, said third cord being capable of supporting said mouthpiece at said first position.

19. The portable communication device of claim 18, wherein said first cord is continuous with said second cord so that said first cord, said second cord and said mouthpiece form a continuous loop.

20. The portable communication device of claim 18, wherein said mouthpiece includes a first side and a second side opposite said first side, said first side being effective to support said first and second cords and said second side being effective to support said third cord.

21. The portable communication device of claim 18, further comprising an earpiece attached to said third cord, said earpiece being effective to support said third cord and said mouthpiece at said first position.

22. The portable communication device of claim 18, wherein said first and second cords effectively center said mouthpiece in front of said user when said third cord supports said mouthpiece at said first position.

23. The portable communication device of claim 18, wherein said second cord is continuous with said third cord, said second and third cords being effective to pass through said mouthpiece.

24. A wireless communication device comprising:
a cord including first and second ends, a body located between said first and second ends, and an electrical conductor extending through said body to connect said first and second ends;
a mouthpiece including a circuit portion to receive said first end of said cord and a retaining portion to receive a subsection of said body of said cord, said circuit portion being coupled to said electrical conductor, said retaining portion capable of being adjustably positioned along said body of said cord; and
an earpiece connected to said second end of said cord, said earpiece being coupled to said electrical conductor.

25. The wireless communication device of claim 24, wherein said circuit portion of said mouthpiece includes a wireless transceiver and a microphone.

26. The wireless communication device of claim 24, wherein said earpiece includes a speaker.

27. The wireless communication device of claim 24, wherein said retaining portion of said mouthpiece maintains itself at a particular position along said body by holding an outer peripheral surface of said body.
